(19) United States
(12) Patent Application Publication
(10) Pub. No.: US 2013/0109728 A1
(43) Pub. Date: May 2, 2013

(54) BIOCIDE COMPOSITION

(71) Applicant: Carsten BERG, Borre (DK)

(72) Inventor: Carsten BERG, Borre (DK)

(73) Assignee: TITAN CHEMICALS LIMITED, Tortola (VG)

(21) Appl. No.: 13/282,517

(22) Filed: Oct. 27, 2011

(51) Int. Cl. A01N 43/80; A01P 1/00

(52) U.S. Cl. 514/373

(57) ABSTRACT

Aqueous solutions of the tetramethylammonium salt of 1,2-benzisothiazolin-3-one and 2-methylisothiazolin-3-one which are stable even at low temperatures and high concentrations.

This invention relates to biocides. More especially the invention relates to biocides containing 1,2-benzisothiazolin-3-one. 1,2-benzisothiazolin-3-one sometimes referred to hereinafter as BIT is a well-known biocide (having CAS# 2634-33-5) which is used inter alia in paint and in water cooling systems. BIT itself is not very water soluble. While it can be used either as a suspension or as a solution in an organic solvent neither option is especially favourable. In the case of suspensions settling can occur leading to difficulties in dosage. The problems of using solutions based on volatile organic solvents are well known. U.S. Pat. No. 6,361,788 describes synergistic combinations of BIT and another biocide 2-methylisothiazolin-3-one having CAS # 2682-20-4 sometimes referred to herein as MIT. In order to maintain the material as a homogenous fluid especially at low temperatures it is necessary to add organic solvent leading to the problems described above.

It has been proposed to use salts of BIT. These salts are water soluble and this overcomes the problems of using suspensions and organic solutions and water solutions of salts of BIT for example the sodium salt are useful in warm environments. Solutions of BIT salts crystallise at comparatively high temperatures and so water solutions of them are not useful at low temperatures unless stabilised by the addition of organic materials such as glycol.

Many salts of BIT are known. For example U.S. Pat. No. 3,970,755 describes a range of quaternary ammonium salts of BIT. WO 02 14 293 also describes a number of salts of BIT. Furthermore WO 02 14 293 measures the freezing point of solutions of the salts it describes. In this document the minimum freezing point of a water solution of a range salts of BIT was reported. Among these results is reported data for the tetramethylammonium salt of BIT hereinafter referred to as “tetramethylammonium BIT”. The lowest freezing point water solution was found to contain 59 wt % tetramethylammonium BIT which corresponds to 40 wt % BIT and have a freezing point of 3° C. after storage for 24 hours and seeding with solid tetramethylammonium BIT.

Solutions of MIT in water freeze at about 0° C.

It has now been surprisingly found that aqueous mixtures of tetramethylammonium BIT and MIT have a low freezing point even below 0° C. especially at relatively high concentrations of tetramethylammonium BIT.

According to the invention there is therefore provided an aqueous solution comprising tetramethylammonium 1,2-benzisothiazolin-3-one and 2-methylisothiazolin-3-one. The aqueous solution can consist essentially of water, tetramethylammonium 1,2-benzisothiazolin-3-one and 2-methylisothiazolin-3-one. The aqueous solution can have a freezing point less than 0° C., for example less than −1° C., −2° C., −3° C., −4° C., −5° C. or lower. The aqueous solution can comprise about 5 to 43 wt % tetramethylammonium 1,2-benzisothiazolin-3-one salt calculated as 1,2-benzthiazolin-3-one. The aqueous solution can comprise about 10 to 25 wt % tetramethylammonium 1,2-benzisothiazolin-3-one calculated as 1,2-benzthiazolin-3-one. The aqueous solution can comprise about 5 to 25 wt % 2-methylisothiazolin-3-one. The aqueous solution can comprise about 7 to 15 wt % 2-methylisothiazolin-3-one.

The invention further provides a process for preparing a biocide comprising the steps of

i) reacting an aqueous solution of tetramethylammonium hydroxide with 1,2-benzisothiazolin-3-one and

ii) adding 2-methylisothiazolin-3-one to the reaction mixture. The aqueous solution of tetramethylammonium hydroxide can contain about 5 to 25 wt % tetramethylammonium hydroxide.

The invention still further provides a method of killing a microorganism comprising contacting the microorganism with the inventive composition.

Low freezing points such as less than about 0° C. for example less than about −3° C. such as less than about −5° C. preferably less than about −7° C. more preferably less than about −12° C. such as less than about −15° C. are achievable over a wide range of concentrations of each ingredient even in the absence of a water-miscible organic solvent.

If even lower freezing points are required than are achievable with only water it is possible to add a water miscible-organic solvent. Examples of such water-miscible organic solvents can include aliphatic alcohols having 1 to 4 carbon atoms such as ethanol and isopropanol, glycols such as ethylene glycol, diethylene glycol, 1,2-propylene glycol, dipropylene glycol and tripropylene glycol, glycol ethers such as butyl glycol and butyl digylcol, glycol esters such as 2,2,4-trimethylpentanediol monoisobutyrate, polyethylene glycol, polypropylene glycol, N,N-dimethylformamide and mixtures thereof.

The pH of the composition is generally neutral or slightly alkaline for example about 8 to about 10.

As explained the composition has a low freezing point over a wide range of BIT and MIT contents. Commercially it is convenient to for the BIT and MIT content to mirror the content of commercially available BIT/MIT compositions to reduce the need for reformulation. For example the content calculated as BIT may be in ranges delimited by about 1, 2, 5, 10, 15 and 20 wt %. The content of MIT may be in ranges delimited by about 5, 8, 10, 15, 20 and 25 wt %.

In other commercially desirable embodiments solutions which are more concentrated than currently easily commercially available solutions of BIT and MIT may be provided. These embodiments have advantages of reduced bulk and hence reduced shipping and storage costs. The BIT content (as BIT) may be more than about 20 wt % for example more than about 25 wt % such as more than about 30 wt % or more than about 35 wt % such as more than about 40 wt % for example more than about 43 wt %. The MIT content may be more than about 5 wt %, 10 wt %, 15 wt %, 20 wt %, 25 wt %, 30 wt % or 35 wt %.

The relative proportions of the BIT and MIT may be varied over a large range while still maintaining a low freezing point. Changes in the relative proportions of them may have an effect on the biocidal properties of the composition with some proportions being especially efficacious in killing particular microorganisms. Typical weight ratios tetramethylammonium BIT (calculated as BIT):MIT can be in the range about 1:5 to 5:1 for example about 1:3 to 3:1.

The composition may be prepared by blending solutions of tetramethylammonium BIT and MIT.

In preferred embodiments the tetramethylammonium BIT is made by reacting BIT with tetramethylammonium hydroxide solution and then adding MIT for example as a concentrated water solution to the mixture. By appropriate selection of reactant concentrations it is often possible to make solutions of the desired strength without concentration or dilution being required.

While tetramethylammonium hydroxide pentahydrate is available it may be too expensive to be commercially viable for use. The most concentrated tetramethylammonium hydroxide solution currently easily commercially available is a 25 wt % solution. If this is reacted with BIT it will produce a solution containing 39 wt % tetramethylamnnonium BIT (which corresponds to 26 wt % BIT) and this will place a limit on the maximum content of BIT in the composition. If greater concentrations of BIT are required they are easily achievable by preparing concentrating, optionally even to dryness, a solution of tetramethylammonium BIT to the appropriate concentration.

If required other materials such as the water miscible solvent can be added.

The other materials can include other biocides. Specific examples of such additional active biocidal substances include benzyl alcohol, 2,4-dichlorobenzyl alcohol, 2-phenoxyethanol, 2-phenoxyethanol hemiformal, phenylethyl alcohol, 5-bromo-5-nitro-1,3-dioxane, formaldehyde and formaldehyde source materials, dimethyloldimethyl hydantoin, glyoxal, glutardialdehyde, sorbic acid, benzoic acid, salicylic acid, p-hydroxybenzoic acid esters, chloroacetamide, N-methylolchloroacetamide, phenols, such as p-chloro-m-cresol and o-phenylphenol, N-methylolurea, N,N′-dimethylolurea, benzyl formal, 4,4-dimethyl-1,3-oxazolidine, 1,3,5-hexahydrotriazine derivatives, quaternary ammonium compounds, such as N-alkyl-N,N-dimethylbenzyl ammonium chloride and di-n-decyldimethyl ammonium chloride, cetylpyridinium chloride, diguanidine, polybiguanide, chlorohexidine, 1,2-dibromo-2,4-dicyanobutane, 3,5-dichloro4-hydroxybenzaldehyde, ethylene glycol hemiformal, tetra(hydroxymethyl)phosphonium salts, dichlorophen, 2,2-dibromo-3-nitrilopropionic acid amide, 3-iodo-2-propinyl-N-butyl carbamate, methyl-N-benzimidazol-2-yl carbamate, 2-n-octylisothiazolin-3-one, 4, 5-dichloro-2-n-octylisothiazolin-3-one, 4,5-trimethylene-2-methylisothiazolin-3 one, 2,2′-dithiodibenzoic acid di-N-methylamide, benzisothiazolinone derivatives, 2-thiocyanomethylthiobenzothiazole, C formals, such as 2-hydroxymethyl-2-nitro-1,3-propanediol, 2-bromo-2-nitropropane-1,3-diol, methylene bisthiocyanate, and reaction products of allantoin.

The biocide composition of the invention can also contain other customary constituents known as additives to those skilled in the art in the field of biocides. These are, e.g., thickening agents, defoaming agents, substances to adjust the pH value, perfumes, dispersing agents, and coloring substances.

The biocide composition of the invention can be used in many different fields. It is suitable, for example, for use in paints, plasters, lignosulfonates, chalk suspensions, adhesives, photochemicals, casein-containing products, starch-containing products, bituminous emulsions, surfactant solutions, motor fuels, cleaning agents, cosmetic products, water circulating systems, polymer dispersions, and cooling lubricants, against attack by, for example, bacteria, filamentous fungi, yeasts, and algae.

In practice, the biocide composition can be used either as a ready-to-use mixture or by adding the biocides and the remaining components of the composition separately to the substance to be preserved.

### EXAMPLES

### Example 1

BIT paste (87 wt % BIT 13 wt % water) 11.5 g (corresponding to 10 g BIT) is added with stirring to an aqueous solution (96.4 g of 25 wt % solution containing 24.1 g) of tetramethylammonium hydroxide to give a clear solution of pH9.0. To this solution was added an aqueous solution of MIT (53 wt % solution containing 18.9 g MIT) with stirring to give a homogenous solution having of pH 9.05 at 23.5° C. and containing 10 wt % of each of BIT and MIT. The solution was stable at −4.5° C. for 24 hours even when seeded with solid tetramethylammonium BIT.

### Example 2

Example 1 was repeated save that 17.2 g BIT paste, 36.2 g tetramethylammonium hydroxide and 28.3 g MIT were used to produce a solution containing 15 wt % of each of BIT and MIT again having a pH of 9.05 at 23.5° C. This solution was stable to −6.5° C. for 24 hours even when seeded with solid tetramethylammonium BIT.

### Example 3

Example 1 was repeated save that 28 g BIT paste, 57 g tetramethylammonium hydroxide and 15 g MIT were used to produce a solution containing 24 wt % BIT and 8 wt % MIT. The resulting solution was stable to −12.5° C. for 24 hours even when seeded with solid tetramethylammonium BIT.

In comparison with these figures it will be recalled that the minimum freezing point previously reported in WO 02 14 293 for tetramethylammonium BIT alone is 3° C. for a 40 wt % solution (calculated as BIT). The results reported are thus clearly unexpectedly superior to those reported for tetramethylammonium BIT alone.

1. An aqueous solution comprising tetramethylammonium 1,2-benzisothiazolin-3-one and 2-methylisothiazolin-3-one.

2. The aqueous solution of claim 1 consisting essentially of water, tetramethylammonium 1,2-benzisothiazolin-3-one and 2-methylisothiazolin-3-one.

3. The aqueous solution of claim 1 having a freezing point less than 0° C.

4. The aqueous solution of claim 1 comprising about 5 to 43 wt % tetramethylammonium 1,2-benzisothiazolin-3-one calculated as 1,2-benzisothiazolin-3-one.

5. The aqueous solution of claim 4 comprising about 10 to 25 wt %.

6. The aqueous solution of claim 1 comprising about 5 to 25 wt % 2-methylisothiazolin-3-one.

7. The aqueous solution of claim 6 comprising about 7 to 15 wt % 2-methylisothiazolin-3-one.

8. The aqueous solution of claim 1 comprising at least about 10 wt % tetramethylammonium 1,2-benzisothiazolin-3-one calculated as 1,2-benzisothiazolin-3-one and at least about 10 wt % 2-methylisothiazolin-3-one.

9. A process for preparing a biocide comprising the steps of
i) reacting an aqueous solution of tetramethylammonium hydroxide with 1,2-benzisothiazolin-3-one and
ii) adding 2-methylisothiazolin-3-one to the reaction mixture.

10. The process of claim 9 wherein said aqueous solution of tetramethylammonium hydroxide contains about 5 to 25 wt % tetramethylammonium hydroxide.

11. A method of killing a microorganism comprising contacting the microorganism with the solution of claim 1.
